(19) United States
(12) Patent Application Publication
(10) Pub. No.: US 2026/0098515 A1
(43) Pub. Date: Apr. 9, 2026

(54) Wind Turbine

(71) Applicant: Enturi Limited, Connah's Quay (GB)

(72) Inventors: Alex Shakeshaft, Connah's Quay (GB); Stuart Roberts, Connah's Quay (GB)

(73) Assignee: Enturi Limited, Connah's Quay (GB)

(21) Appl. No.: 19/120,772

(22) PCT Filed: Jul. 19, 2023
(86) PCT No.: PCT/GB2023/051896

§ 371 Date: Apr. 12, 2025

(30) Foreign Application Priority Data
Oct. 12, 2022 (GB) 2215037.9

(51) Int. Cl. F03D 1/04; F03D 1/06

(52) U.S. Cl. CPC F03D 1/051; F03D 1/0633; F05B 2240/14; F05B 2240/30; F05B 2250/25

(57) ABSTRACT

The invention provides for a turbine, which includes a duct that may provide an elongate circular internal passage that may have an open upstream end forming an intake and an open downstream end forming an exhaust. The turbine may further include a turbine rotor that may be rotatably mounted in and coaxially with the internal passage and may have at least one rotor blade extending helically along the internal passage so that airflow through the internal passage from the intake to the exhaust may impinge on the rotor blade and may drive the turbine rotor to turn. The duct may further provide at least one intermediate inlet disposed between the intake and the exhaust and part way along the rotor blade.

The present invention relates to air-driven and water-driven turbines.

One widespread form of air-driven turbine is the wind turbine. Simple wind turbines have of course been used for centuries to convert the kinetic energy of the wind into usable form, be that to drive a millstone in days gone by or, in more modern times, to drive an electrical generator. Wind turbines come in a wide variety of different forms. Some, such as the well-known Savonius-type turbine, have a fixed vertical axis and are configured to be driven by wind from any compass bearing. Others are driven by the wind to turn about a horizontal axis and are movable also about a vertical axis, to enable them to face into wind. Large-scale horizontal-axis wind turbines of this type, having typically three high-aspect-ratio blades atop a single supporting leg, have been widely adopted in recent decades for electricity generation both on and off shore.

But these large, high-aspect-ratio horizontal-axis turbines have drawbacks, among them the risk they present of bird strikes. There are several aspects of a wind turbine's performance which need to be optimised so far as possible, including energy efficiency and usable wind range. And while there is a place for large-scale turbine installations, there is also a need for smaller turbines capable of straightforward installation on small sites, which may be proximate to the point of energy usage and so not dependent on connection to the electrical grid.

U.S. Pat. No. 4,218,175A, Carpenter, concerns a wind turbine having a rotor in the form of a cone provided with upstanding helical vanes, contained in what is referred to as a wind tunnel. This tunnel has an inlet upstream of the turbine rotor which is of frusto-conical form, converging along the direction of airflow and said to provide an increase in speed of wind flow by the venturi principle. The inlet leads to a “throat area” of divergent conical form containing the turbine itself. Whether this provides an efficient machine for harvesting wind energy is questionable.

US2011/0115230A1, Urch, describes a “power generator” said to have multiple functions not limited to harvesting of wind energy—it is described also for use with water flows, and is said to be able to serve as a pump. It has a rotor comprising a vane arrangement whose diameter diminishes along the direction of flow, and a housing around the rotor which is said to rotate along with it. A sprung arrangement enables the pitch of the rotor to adjust according to operating conditions. Whether this would have been a practical device, or an efficient one, is again questionable. Another example of a turbine using a rotor having helical blades disposed in a housing, and a diameter which diminishes along the flow direction, is provided by WO2012/067501A1, Stichting S & O Patenten.

KR20180024874A, Lee Jong Mo, depicts a device having a multi-turn turbine rotor whose diameter increases along the flow direction, housed in a complementarily shaped housing and provided with what appears to be an air scoop at the inlet end of the housing.

The present inventors have recognised that the performance of a wind turbine of the type comprising a turbine rotor within a duct or housing can be improved by suitable design of the duct.

According to the present invention, there is a fluid-driven turbine comprising a duct which provides an elongate circular internal passage having an open upstream end forming an intake and an open downstream end forming an exhaust, and a turbine rotor rotatably mounted in and coaxially with the internal passage, the turbine rotor comprising at least one rotor blade which extends helically along the internal passage so that airflow through the internal passage from the intake to the exhaust impinges on the rotor blade and drives the turbine rotor to turn, and the duct comprising at least one intermediate inlet disposed between the intake and the exhaust and part way along the rotor blade.

Specific embodiments of the present invention will now be described, by way of example only, with reference to the accompanying drawings, in which:—

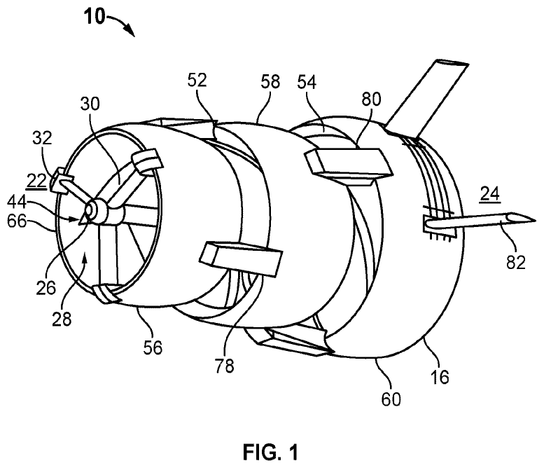

FIG. 1 depicts a wind turbine embodying the present invention, viewed from in front and to one side;

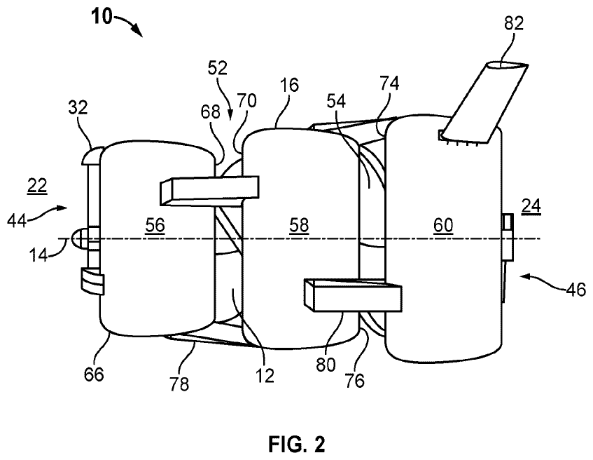

FIG. 2 depicts the wind turbine of FIG. 1 in side elevation;

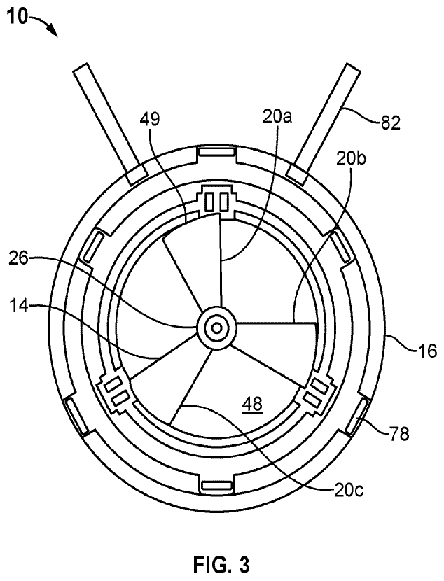

FIG. 3 depicts the wind turbine of FIG. 1 in front elevation;

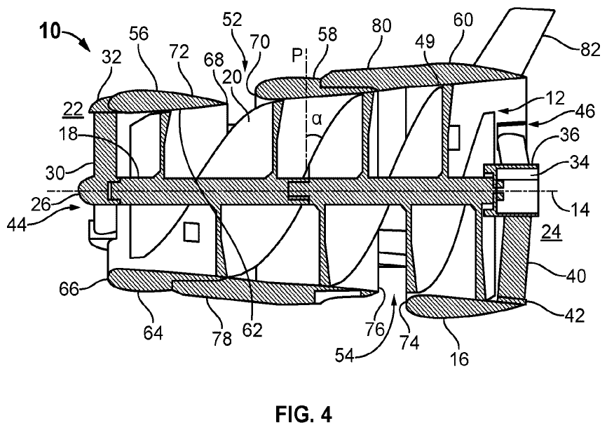

FIG. 4 is a section through the wind turbine of FIG. 1 in an axial plane; and

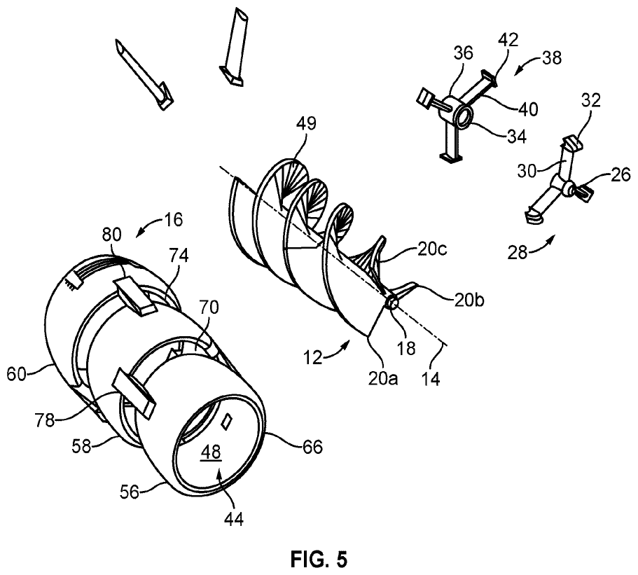

FIG. 5 is an exploded view of components of the wind turbine of FIG. 1.

The depicted embodiment is a horizontal-axis turbine 10 having a turbine rotor 12 mounted for rotation within a duct 16.

The present embodiment is a wind turbine. The assembly of the duct 16 and the rotor 12 is to be mounted in use in a manner that enables it to turn about a substantially vertical axis to face into wind. It is to be understood however that the invention may be applied to air and water-driven turbines at large, and is not limited to wind turbines only.

The turbine rotor 12 is driven by fluid flow-specifically in this example by wind-to harvest energy. It comprises a shaft 18 (seen in FIGS. 4 and 5) defining the turbine rotor's rotational axis 14 and carrying helical turbine blades 20. The rotational axis 14 of the turbine rotor 12 coincides with an axis of symmetry of the duct 16, which is annular in radial section. In the present embodiment there are three turbine blades 20a-20c arranged at 120-degree intervals in the manner of a multi-start screw thread. Other embodiments of the invention could utilise a different number of turbine blades 20. In the present embodiment, each of the turbine blades 20 describes a little more than one full turn about the turbine rotor's rotational axis 14.

The turbine 10 has an upstream end 22 and a downstream end 24. The diameter of the turbine blades 20a-20c increases somewhat in the direction toward the downstream end 24, as FIG. 4 shows. It may be observed in FIGS. 4 and 5 that the pitch of each of the helical blades 20 diminishes somewhat in the direction toward the downstream end 24. That is, the angle a (see FIG. 4) that the blade 20, viewed along a radial direction as in FIG. 4, makes to a plane P perpendicular to the axis gets smaller toward the downstream end 24.

The turbine rotor 12 may be manufactured using any suitable technique and materials, but in the present embodiment it is an injection-moulded item comprising fibre reinforcement. The result is a fibre-reinforced plastic composite.

Bearings are provided at either end of the turbine rotor 12 to rotatably mount it within the duct 16. The upstream end of the shaft 18 is received in a bearing (not itself shown in the drawings) carried in an upstream hub 26 of an upstream bearing carrier 28. The bearing carrier 28 needs to position the upstream hub 26 on the axis 14 without unduly impairing airflow through the duct 16. In the present embodiment it comprises three radially-extending limbs 30 each having a respective foot 32 to engage with the duct's upstream end. At the downstream end of the shaft 18, the required bearing is part of an electrical generator 34 carried in a downstream hub 36 of a downstream bearing carrier 38, which again has a tripedal structure whose radially-extending limbs 40 terminate in feet 42 to engage with the duct 16.

The electrical generator 34 is driven by the turbine rotor 12 to generate electrical power. Any suitable form of generator may be adopted, be it a dynamo, alternator etc. Its output may be direct or alternating current. The electrical generator may be driven from the turbine rotor 12 through a gear train or other mechanism for changing rotational speed, such as a chain or belt drive, but in the present embodiment it is driven directly by the turbine rotor 12 and is arranged co-axially with it.

The duct 16 contributes to the performance of the turbine 10. It forms a route for air flow which leads from an open upstream end forming an intake 44, to an open downstream end forming the duct's exhaust 46, via an internal passage 48 which contains the turbine rotor 12 and which has a circular shape in radial section as seen in FIG. 3. Diameter of the internal passage 48 is complementary to that of the turbine rotor 12, increasing somewhat along the direction toward the downstream end 24. Outer edges 49 of the turbine blades 20 lie adjacent the duct's internal surface 50 defining the passage 48, minimising air flow past the outer edges 49 which would otherwise impair efficiency.

The duct 16 has first and second intermediate inlets 52, 54 between the intake 44 and the exhaust 46. The intermediate inlets 52, 54 serve to admit additional airflow into the passage 48, augmenting the airflow available to drive the rotor 12 and so increasing the turbine's energy output. Because the helical blades 20 extend along the length of the duct 16, the additional airflow is able to impinge directly on intermediate regions of the blades 20, between their upstream and downstream ends. The duct 16 is shaped to divert flow (wind, in the present example) over its exterior surface radially inwardly, into the intermediate inlets 52, 54, as will now be explained.

Referring in particular to FIG. 4, the duct 16 of the present embodiment is seen to comprise first, second and third wall portions 56, 58, 60. The first wall portion 56 is at the duct's upstream end and forms the intake 44. In radial section (FIG. 3) the first wall portion 56 is annular. In axial section (FIG. 4) it has the shape of an aerofoil. A very wide range of different aerofoil sections is known to the skilled person, and could be adopted in embodiments of the present invention, but the aerofoil section chosen in the present embodiment is of conventional type, having a flat underside 62 which faces radially inward, toward the passage 48, a convex topside 64 which faces radially outward, a leading edge 66 which faces upstream, and a trailing edge 68 which faces downstream.

The second wall portion 58, similarly to the first, is annular in radial section and has the shape of an aerofoil in axial section, its leading edge 70 facing upstream. The trailing edge 68 of the first wall portion is separated along the airflow direction from the leading edge 70 of the second wall portion to form the first intermediate inlet 52.

When fluid, be it air or water, flows over the duct 16, the effect of the aerofoil section of the first wall portion 56 is to divert airflow close to the duct's outer surface along a radially inwardly-inclined path, to enter the duct 16 through the first intermediate inlet 52. A rear, outer portion 72 of the aerofoil section of the first wall portion 56 is seen to be inclined radially inwardly. Airflow in the region close to the first wall portion 56 tends to follow the same radially inwardly-inclined path, to enter the passage 48 through the first intermediate inlet 52. To put this another way, the effect of the aerofoil section of the wall portion 56 is to create a region of low pressure along at least part of the section's convex topside 64. This low-pressure region serves to deflect airflow along the radially inwardly-inclined path by which the airflow enters the duct 16.

The third wall portion 60, similarly to the first and second, is annular in radial section and has the shape of an aerofoil in axial section, its leading edge 74 facing upstream. Trailing edge 76 of the second wall portion is separated along the airflow direction from leading edge 74 of the third wall portion to form the second intermediate inlet 54. The aerofoil shape of the second wall section 58 causes airflow over it to be diverted into the duct 16 through the second intermediate inlet 54, in the manner already described with reference to the first wall section 56. Thus the turbine blades are driven not only by airflow through the intake 44 but also by airflow through the two separate intermediate inlets 52, 54, maximising the power available from the turbine rotor 12.

The effect of the aerofoil section of the third wall portion 60 is to divert airflow over it along a radially-inwardly-inclined path, tending to increase local air velocity in the region of the exhaust 46 and hence to reduce pressure in that region. An increase of air velocity through the passage 48 is thereby provided.

The first wall portion 56 is coupled to the second wall portion 58 through spacer parts 78 arranged at circumferential intervals. Likewise the second wall portion is coupled to the third wall portion through spacer parts 80 at circumferential intervals.

As noted already, since this example takes the form of a wind turbine, the assembly comprising the duct 16 and rotor 12 needs to be able to turn about a vertical axis to face into wind. Any suitable mechanism may be adopted for this purpose but in the present embodiment the duct 16 carries steering vanes 82 at or toward its downstream end, and a freely-turning vertical-axis mounting (not shown) carries the duct 16, so that the vanes are able to move the duct 16 to face into wind, in the manner of a weathervane.

The invention imposes no limit on the size of the rotor 12 and its duct 16, but the rotor diameter may be in the range from 0.4 metres to 2 metres.

In the illustrated embodiment the diameter of the passage 48 and the diameter of the turbine blades 20 increase somewhat in the downstream direction. But in other embodiments this feature may be dispensed with so that for example both may have diameters which are substantially constant along their length.

While the depicted embodiment is a wind turbine, the invention may also be applied e.g. to a submerged water turbine, which might for example be sited in a suitable river or in a region of the sea experiencing suitably rapid tidal flow.

1. A turbine driven by at least one of air and water, the turbine comprising:
a duct having an internal surface which forms an elongate circular internal passage having an open upstream end and an open downstream end, wherein the open upstream end forms an intake, and wherein the open downstream end forms an exhaust; and
a turbine rotor rotatably mounted in and coaxially with the elongate circular internal passage;
wherein the turbine rotor comprises at least one rotor blade;
wherein the at least one rotor blade extends helically along the elongate circular internal passage so that flow through the elongate circular internal passage from the intake to the exhaust impinges on the at least one rotor blade and drives the turbine rotor to turn;
wherein the at least one rotor blade has outer edges which lie adjacent to the internal surface of the duct;
wherein the duct comprises at least one intermediate inlet disposed between the intake and the exhaust and part way along the at least one rotor blade; and
wherein the at least one intermediate inlet communicates with the elongate circular internal passage so that flow through the at least one intermediate inlet augments flow through the elongate circular internal passage.

2. The turbine of claim 1, wherein the at least one intermediate inlet is configured so that in operation, flow from outside the duct passes into the elongate circular internal passage through the at least one intermediate inlet and impinges on the at least one rotor blade.

3. The turbine of claim 1, wherein the duct is shaped to divert flow over an exterior of the duct into the elongate circular internal passage through the at least one intermediate inlet.

4. The turbine of claim 1, wherein the at least one intermediate inlet comprises a circumferentially-extending opening in a wall of the duct.

5. The turbine of claim 1, wherein the duct comprises a wall portion which, in axial section, has an aerofoil shape including a trailing edge that is toward a downwind end and is contiguous with the at least one intermediate inlet.

6. The turbine of claim 5, wherein the wall portion is annular in radial section.

7. The turbine of claim 1, wherein the duct comprises at least two intermediate inlets at intervals along the elongate circular internal passage.

8. The turbine of claim 1, wherein the duct comprises a first wall portion, a second wall portion downwind of the first portion, and a third wall portion downwind of the second portion; and wherein the at least one intermediate inlet is formed between the first wall portion and the second wall portion and a second intermediate inlet is formed between the second wall portion and the third wall portion.

9. The turbine of claim 8, wherein the first wall portion and the second wall portion each have an aerofoil shape in axial section.

10. The turbine of claim 1, further comprising at least two helical blades at angular intervals to one another about the turbine rotor's rotational axis.

11. The turbine of claim 1, wherein the elongate circular internal passage has a diameter which increases progressively in a direction from the upwind end to the downwind end.

12. The turbine of claim 1, wherein the at least one rotor blade has a helix pitch which diminishes progressively in a direction from the upwind end to the downwind end.

13. The turbine of claim 1, wherein the at least one rotor blade has a maximum radius and an axial length; and wherein the axial length is at least twice the maximum radius.

14. The turbine of claim 1, wherein the turbine comprises a wind turbine.
